(19) United States
(12) Patent Application Publication
(10) Pub. No.: US 2006/0113990 A1
(43) Pub. Date: Jun. 1, 2006

(54) Linear position sensor

(75) Inventor: Dieter Schodlbauer, Munchen (DE)

Correspondence Address: SENNIGER POWERS, ONE METROPOLITAN SQUARE, 16TH FLOOR, ST LOUIS, MO, 63102, US

(73) Assignee: Bourns, Inc., Riverside, CA (US)

(21) Appl. No.: 11/288,715

(22) Filed: Nov. 29, 2005

(30) Foreign Application Priority Data
Nov. 30, 2004 (DE) 10 2004 057 909.1

(51) Int. Cl. G01B 7/30

(52) U.S. Cl. 324/207.24; 324/207.2

(57) ABSTRACT

The linear position sensor has a permanent magnet and a magnetic field sensor, which generates an output signal dependent on the direction of the magnetic field. The permanent magnet and the magnetic field sensor are moveable relative to each other along the linear movement path. An evaluation circuit converts the output signal of the magnetic field sensor to a signal that corresponds to a relative position between the magnetic field sensor and the permanent magnet along said linear movement path.

### REFERENCE TO RELATED APPLICATION

This application claims priority from German patent application 10 2004 057 909.1 filed Nov. 30, 2004.

### FIELD OF THE INVENTION

The invention pertains to a linear position sensor of the type having a permanent magnet and a magnetic field sensor which are moveable relative to each other.

### BACKGROUND OF THE INVENTION

Such a position sensor is known for example from EP 0 596 068 B1 (corresponds to DE 693 06 085 T2). There a permanent magnet connected to a linearly moveable component can be moved linearly in a main air gap between two ferromagnetic stator parts, wherein one of the stator parts has a secondary air gap in which a magnetic field sensor is arranged. A magnetic field sensor of the Hall type is arranged in the secondary air gap so that the magnetic field lines run essentially perpendicular to the surface of the magnetic field sensor and only the field intensity varies during movement of the permanent magnet.

DE 102 19 473 B3 shows a measurement device with a Hall sensor arranged centrally and axially moveable in a magnetic tube, wherein the magnetic tube is transversely magnetized in each half with opposite polarity.

DE 197 01 927 C1 shows a sensor for recording a rotational or translatory movement with a permanent magnet that generates a symmetric magnetic field and a similar magnetosensitive sensor element aligned so that the normal vector of the sensitive surface of the sensor element has an angle to a vector pointing from the sensor element perpendicular to the axis of the permanent magnet. Because of this a nonsymmetric voltage pattern of the output signal of the sensor element can be achieved so that a direction reversal of movement can easily be recorded.

The symmetric magnetic field is also generated by a transversely magnetized hollow cylindrical magnet.

### SUMMARY OF THE INVENTION

Among the various aspects of the invention is to improve a position sensor of the type just mentioned so that precise path measurement is made possible in a simplified design.

Briefly, therefore, the invention is directed to a linear position sensor comprising a permanent magnet having a magnetic field having a direction; a magnetic field sensor disposed in the magnetic field which generates an output signal dependent upon the direction of the magnetic field, wherein the permanent magnet and magnetic field sensor are linearly moveable relative to each other along a linear movement path; and an evaluation circuit which converts the output signal of the magnetic field sensor to a signal that corresponds to the linear movement path between the magnetic field sensor and the permanent magnet.

Additional aspects and features are in part apparent and in part pointed out below.

### BRIEF DESCRIPTION OF THE FIGURES

FIG. 1, a sketch of a position sensor to explain the basic principle of the invention;

FIG. 2, a sketch of the position sensor according to one embodiment of the invention; and

FIG. 3, a specific embodiment of the position sensor according to the invention.

### DETAILED DESCRIPTION OF THE PREFERRED EMBODIMENTS

This application claims priority from German patent application 10 2004 057 909.1 filed Nov. 30, 2004, the entire disclosure of which is expressly incorporated herein by reference.

The basic principle of the invention is that a magnetic field sensor is used whose output signal depends on the direction of the magnetic field flowing through it. Since the direction of the magnetic field of a permanent magnet changes in location-dependent fashion, a signal indicating the relative position between the magnetic field sensor and the permanent magnet can therefore be generated from the direction of the magnetic field and therefore from the output signal of the direction-dependent magnetic field sensor. This can then be converted by an evaluation unit, as required, into a signal directly proportional to the path being measured, which latter signal is present for example, as an analog signal, a digital signal or a pulse width-modulated signal.

The magnetic field sensor is preferably constructed from magnetoresistive elements whose ohmic resistance depends on the angle between a current flowing through the sensor and the magnetic field direction. In one embodiment the magnetoresistive elements are of the type KMZ 43 available from Philips.

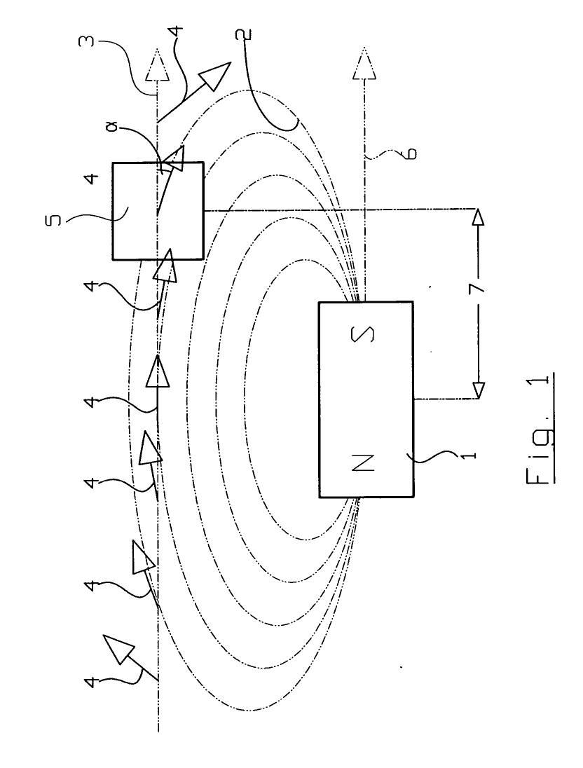

A permanent magnet 1 is shown in FIG. 1, and is magnetized in the axial direction and generates a magnetic field 2 indicated by the dashed magnetic field lines. If one views the magnetic field pattern along a trajectory 3, it is found that not only the magnitude but also the direction of the local magnetic field changes along this trajectory. This direction is shown by arrow 4. If a magnetic field sensor 5 now moves along this trajectory 3, it receives magnetic field lines of a different direction corresponding to arrows 4 as a function of location in the longitudinal direction of trajectory 3, which arrows indicate the local direction of the magnetic field at different locations of trajectory 3. Conversely, the permanent magnet 1 can also be shifted together with this magnetic field 2 along arrow 6 and the magnetic field sensor 5 can be arranged fixed, wherein the movement path of arrow 6 then lies parallel to trajectory 3.

The magnetic field sensor 5 is designed as a direction-dependent sensor, for example an AMR sensor. In one embodiment the field direction-sensitive magnetic field sensor is constructed from Hall-effect plates, such as a Hall-sensor of the type MLX 90316 available from Melexis Microelectronic Systems of Concord, N.H. (USA) and Erfurt (Germany).

The magnetic field lines 2 are schematically depicted in FIG. 1 in roughly the shape of an ellipse. It is apparent that the angle α between the local magnetic field direction (cf. arrow 4) and trajectory 3 is not linearly dependent on the relative movement path 7 between permanent magnet 1 and magnetic field sensor 5, but varies according to a continuous function.

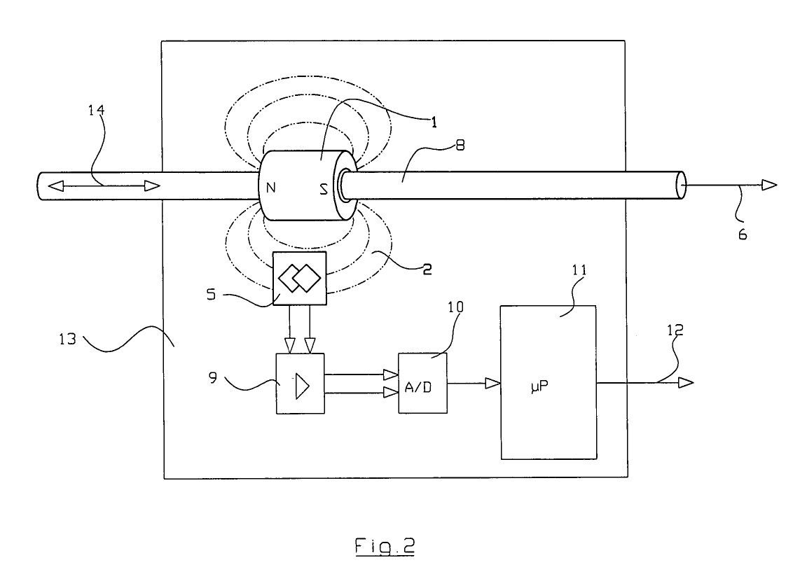

FIG. 2 shows in simplified form the principle of a linear position sensor in which a hollow cylindrical permanent magnet 1 is used, which is fastened on an axially moveable cylindrical rod 8, wherein its relative position is to be measured with reference to the fixed magnetic field sensor 5. The permanent magnet 1 again generates a magnetic field 2 whose magnitude and direction at the location of magnetic field sensor 5 depend on the position of the magnet 1 along a motion path 6. The magnetic field sensor 5 records the magnetic field 2 in a plane passing through the center of rod 8, preferably in direction and magnitude. Two analog voltage values are then available as raw measurement data, which are preprocessed in a downline amplifier stage 9 and fed to an analog/digital converter 10. After conversion to digital numerical values, determination of the local magnetic field direction and its assignment to the desired measured quantity, i.e., the linear motion path, occurs in a calculation stage 11. Additional systematic corrections can also be made in the calculation stage 11.

The magnetic field sensor 5, the amplifier 6, the analog/digital converter 10 and the calculation stage 11 can be combined in an integrated component. At the signal output 12 of calculation stage 11, the sought path information is produced as a signal, which can be made available in digital form or also analog or pulse-width-modulated form.

The previously described parts can be arranged in a common housing 13, wherein the rod 8 together with magnet 1 can be moved relative to the housing, as shown by arrow 14. The magnetic field sensor 5 is then arranged fixed in housing 13.

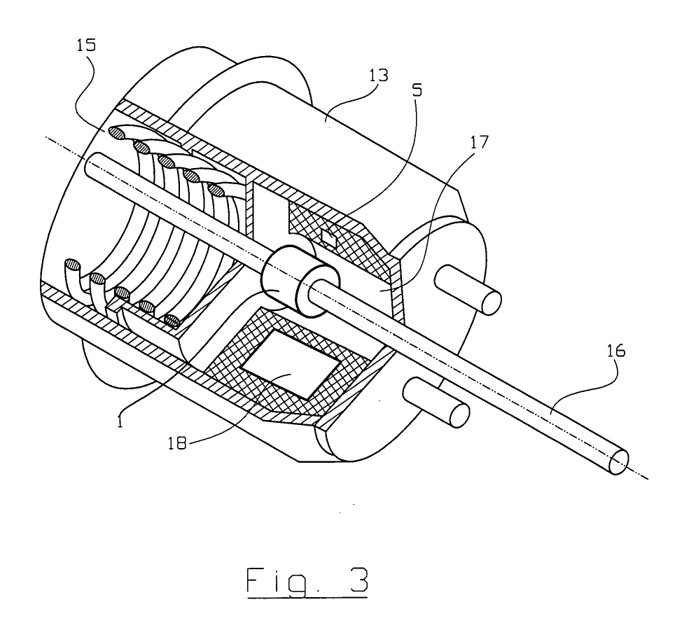

As an example, FIG. 3 shows an embodiment of the linear path sensor in conjunction with a vacuum box 15, whose plunger 16 is moved linearly as a function of pressure, wherein its position or deflection is to be determined.

The plunger 16 is mounted to move linearly in housing 13 and carries in the interior of a chamber 17 the permanent magnet 1, in whose magnetic field (not shown) the magnetic field sensor 5 lies. The evaluation circuit is also accommodated in chamber 13, and consists of the aforementioned components of amplifier 9, the A/D converter 10 and the calculation stage 11. These components are indicated together by a block 18, which is arranged in chamber 17.

It is clear to one skilled in the art that the invention is applicable to any form of linear path sensor and is not restricted to the example of a vacuum box described here.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above methods and products without departing from the scope of the invention, it is intended that all matter contained in the above description and shown in the accompanying drawings shall be interpreted as illustrative and not in a limiting sense.

What is claimed is:

1. A linear position sensor comprising:
a permanent magnet having a magnetic field having a direction;
a magnetic field sensor disposed in the magnetic field which generates an output signal dependent upon the direction of the magnetic field, wherein the permanent magnet and magnetic field sensor are linearly moveable relative to each other along a linear movement path; and
an evaluation circuit which converts the output signal of the magnetic field sensor to a signal that corresponds to a relative position between the magnetic field sensor and the permanent magnet along said linear movement path.

2. The linear position sensor according to claim 1 wherein the magnetic field sensor is constructed from magnetoresistive elements.

3. The linear position sensor according to claim 2 wherein the field direction-sensitive magnetic field sensor is constructed from Hall-effect plates.

4. The linear position sensor according to claim 1 wherein the permanent magnet is firmly connected to a component linearly moveable relative to a housing within which the magnetic field sensor fixed.

5. The linear position sensor according to claim 2 wherein the permanent magnet is firmly connected to a component linearly moveable relative to a housing within which the magnetic field sensor fixed.

6. The linear position sensor according to claim 3 wherein the permanent magnet is firmly connected to a component linearly moveable relative to a housing within which the magnetic field sensor fixed.

7. The linear position sensor according to claim 4 wherein the permanent magnet is a hollow cylindrical magnet magnetized in the axial direction.

8. The linear position sensor according to claim 5 wherein the permanent magnet is a hollow cylindrical magnet magnetized in the axial direction.

9. The linear position sensor according to claim 6 wherein the permanent magnet is a hollow cylindrical magnet magnetized in the axial direction.

10. The linear position sensor according to claim 1 wherein the evaluation circuit comprises a calculation unit.

11. The linear position sensor according to claim 10 wherein the evaluation circuit further comprises an amplifier and an analog/digital converter.

12. The linear position sensor according to claim 2 wherein the evaluation circuit comprises a calculation unit.

13. The linear position sensor according to claim 12 wherein the evaluation circuit further comprises an amplifier and an analog/digital converter.

14. The linear position sensor according to claim 3 wherein the evaluation circuit comprises a calculation unit.

15. The linear position sensor according to claim 14 wherein the evaluation circuit further comprises an amplifier and an analog/digital converter.

16. The linear position sensor according to claim 4 wherein the evaluation circuit comprises a calculation unit.

17. The linear position sensor according to claim 16 wherein the evaluation circuit further comprises an amplifier and an analog/digital converter.

18. The linear position sensor according to claim 7 wherein the evaluation circuit comprises a calculation unit.

19. The linear position sensor according to claim 18 wherein the evaluation circuit further comprises an amplifier and an analog/digital converter.
